(19) United States
(12) Patent Application Publication
(10) Pub. No.: US 2008/0072729 A1
(43) Pub. Date: Mar. 27, 2008

(54) CUTTING APPARATUS

(75) Inventor: Tzu-Feng Tseng, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/625,510

(22) Filed: Jan. 22, 2007

(30) Foreign Application Priority Data
Sep. 8, 2006 (TW) 095133179

(51) Int. Cl. B26D 1/06

(52) U.S. Cl. 83/628; 83/636

(57) ABSTRACT

A cutting apparatus includes a cutting platform, an automatic transmission member, first and second lateral plates, a rotating shaft, a cutting member and an eccentric sustaining member. The automatic transmission member is disposed on the cutting platform. The first and second lateral plates are arranged at opposed sides of the cutting platform. The rotating shaft penetrates through two lateral plates, respectively, wherein an end of the rotating shaft is rotatably connected to a gear part of the gear set. The cutting member is movable along the first guiding track and the second guiding track. The eccentric sustaining member is sheathed around the rotating shaft and disposed above the cutting member. The eccentric sustaining member is sustained against the cutting member to transmit a linear cutting operation of the cutting member when the rotating shaft is driven by the gear part to rotate in a circular motion.

### FIELD OF THE INVENTION

The present invention relates to a cutting apparatus, and more particularly to an automatic cutting apparatus

### BACKGROUND OF THE INVENTION

Conventionally, cutting apparatuses are used for cutting sheet articles such as papers. Typically, the cutting apparatuses are classified into two types, i.e. a small-size manual cutting apparatus for use in homes or offices and a large-size automatic cutting apparatus for use in factories. In other words, the cutting apparatuses applied to homes or offices are usually small and manually operated. Nowadays, since the cutting apparatuses are developed toward increasing diversity, many different types of cutting apparatuses are disclosed. For example, a small-size automatic cutting apparatus is disclosed in Taiwanese Patent Publication No. 1239280, and the contents of which are hereby incorporated by reference.

As known, the configurations of the small-size automatic cutting apparatuses are complicated and costly. For complying with different thickness specifications of sheet articles, many components included in the automatic cutting apparatuses should be replaced with new ones. In other words, the application of individual automatic cutting apparatus is limited. Therefore, there is a need to provide a cutting apparatus having extensible applications and simple configurations.

### SUMMARY OF THE INVENTION

It is an object of the present invention to provide a cutting apparatus having simple configurations.

It is another object of the present invention to provide a cutting apparatus having extensible applications.

In accordance to an aspect of the present invention, there is provided a cutting apparatus. The cutting apparatus includes a cutting platform, a first lateral plate and a second lateral plate, a first guiding track and a second guiding track, a motor, a gear set, a cutting member, a rotating shaft and a rotational direction switching unit. The first lateral plate and the second lateral plate are arranged at opposed sides of the cutting platform. The first guiding track and the second guiding track arranged on the first lateral plate and the second lateral plate, respectively, and face to each other. The motor is disposed on the cutting platform. The gear set includes a first gear part and a second gear part, which are disposed on a first surface and a second surface of the second lateral plate, respectively. The first gear part is rotatably connected to the motor. The cutting member is arranged between the first guiding track and the second guiding track and movable along the first guiding track and the second guiding track. The rotating shaft has a first end and a second end penetrating through the first lateral plate and the second lateral plate, respectively. The second end of the rotating shaft is rotatably connected to the second gear part of the gear set. The rotational direction switching unit is interconnected between the rotating shaft and the cutting member and includes a sustaining member sheathed around the rotating shaft. The sustaining member is sustained against the cutting member thereunder to transmit a linear cutting operation of the cutting member when the rotating shaft is driven by the second gear part of the gear set to rotate in a circular motion.

In an embodiment, the first guiding track and the second guiding track are arranged in a vertical direction such that the cutting member is moved along the first guiding track and the second guiding track to implement the linear cutting operation in the vertical direction.

In an embodiment, the cutting member has a slanted and curved knife edge.

In an embodiment, the second gear part of the gear set includes a first gear and a second gear engaging with each other, the first gear of the second gear part is rotatably connected to the first gear part, and the second gear of the second gear part is rotatably connected to the second end of the rotating shaft.

In an embodiment, the sustaining member is an eccentric roller.

In an embodiment, the rotational direction switching unit further includes a ring-shaped collar enclosing the eccentric roller, wherein the eccentric roller has a rolling surface sustained against an inner surface of the ring-shaped collar.

In an embodiment, the cutting apparatus further comprises a coupling member between the ring-shaped collar and the cutting member to transmit the linear cutting operation of the cutting member when the rotating shaft is rotated in the circular motion to have the eccentric roller sustained against the inner surface of the ring-shaped collar.

In an embodiment, the coupling member comprises a clamping block for clamping an upper edge of the cutting member, wherein a first pivotal hole pedestal is extended from a top surface of the clamping block; a second pivotal hole pedestal extended from an outer surface of the ring-shaped collar; and a movable bolt penetrating through the second pivotal hole pedestal and the first pivotal hole pedestal such that the ring-shaped collar is pivotally coupled to the clamping block.

In an embodiment, the first pivotal hole pedestal and the second pivotal hole pedestal are respectively male-shaped and female-shaped, or the first pivotal hole pedestal and the second pivotal hole pedestal are respectively female-shaped and male-shaped.

In accordance to another aspect of the present invention, there is provided a cutting apparatus. The cutting apparatus includes a motor, a gear set, a rotating shaft, a cutting member and an eccentric sustaining member. The gear set includes a first gear part and a second gear part, wherein the first gear part is rotatably connected to the motor. The rotating shaft penetrates through two lateral plates, respectively, wherein an end of the rotating shaft is rotatably connected to the second gear part of the gear set. The cutting member is arranged between a first guiding track and a second guiding track and movable along the first guiding track and the second guiding track. The eccentric sustaining member is sheathed around the rotating shaft and disposed above the cutting member. The eccentric sustaining member is sustained against the cutting member to transmit a linear cutting operation of the cutting member when the rotating shaft is driven by the second gear part of the gear set to rotate in a circular motion.

In an embodiment, the eccentric sustaining member is an eccentric roller.

In an embodiment, the cutting apparatus further comprises a ring-shaped collar and a coupling member. The ring-shaped collar encloses the eccentric roller, wherein the eccentric roller has a rolling surface sustained against an inner surface of the ring-shaped collar. The coupling member is disposed between the ring-shaped collar and the cutting member to transmit the linear cutting operation of the cutting member when the rotating shaft is rotated in the circular motion to have the eccentric roller sustained against the inner surface of the ring-shaped collar.

In an embodiment, the coupling member comprises a clamping block for clamping an upper edge of the cutting member, wherein a first pivotal hole pedestal is extended from a top surface of the clamping block; a second pivotal hole pedestal extended from an outer surface of the ring-shaped collar; and a movable bolt penetrating through the second pivotal hole pedestal and the first pivotal hole pedestal such that the ring-shaped collar is pivotally coupled to the clamping block.

In accordance to another aspect of the present invention, there is provided a cutting apparatus. The cutting apparatus includes a cutting platform, an automatic transmission member, a first lateral plate and a second lateral plate, a rotating shaft, a cutting member and an eccentric sustaining member. The automatic transmission member is disposed on the cutting platform. The first lateral plate and the second lateral plate are arranged at opposed sides of the cutting platform. The rotating shaft penetrates through two lateral plates, respectively, wherein an end of the rotating shaft is rotatably connected to a gear part of the gear set. The cutting member is arranged between a first guiding track and a second guiding track and movable along the first guiding track and the second guiding track. The eccentric sustaining member is sheathed around the rotating shaft and disposed above the cutting member. The eccentric sustaining member is sustained against the cutting member to transmit a linear cutting operation of the cutting member when the rotating shaft is driven by the gear part to rotate in a circular motion.

In an embodiment, the automatic transmission member comprises a motor and a gear set. The motor is disposed on the cutting platform. The gear set includes the gear part and another gear part, which are disposed on opposed surfaces of one lateral plate of the two lateral plates, wherein the another gear part is rotatably connected to the motor.

In an embodiment, the eccentric sustaining member is an eccentric roller.

In an embodiment, the cutting apparatus further comprises a ring-shaped collar and a coupling member. The ring-shaped collar encloses the eccentric roller, wherein the eccentric roller has a rolling surface sustained against an inner surface of the ring-shaped collar. The coupling member is disposed between the ring-shaped collar and the cutting member to transmit the linear cutting operation of the cutting member when the rotating shaft is rotated in the circular motion to have the eccentric roller sustained against the inner surface of the ring-shaped collar.

In an embodiment, the coupling member comprises a clamping block for clamping an upper edge of the cutting member, wherein a first pivotal hole pedestal is extended from a top surface of the clamping block; a second pivotal hole pedestal extended from an outer surface of the ring-shaped collar; and a movable bolt penetrating through the second pivotal hole pedestal and the first pivotal hole pedestal such that the ring-shaped collar is pivotally coupled to the clamping block.

The above objects and advantages of the present invention will become more readily apparent to those ordinarily skilled in the art after reviewing the following detailed description and accompanying drawings, in which:

### BRIEF DESCRIPTION OF THE DRAWINGS

FIGS. 1(a), 1(b) and 1(c) are schematic perspective views illustrating successive operations of a cutting apparatus according to a preferred embodiment of the present invention; and

FIG. 2 is a rear view of the cutting apparatus shown in FIG. 1(a).

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

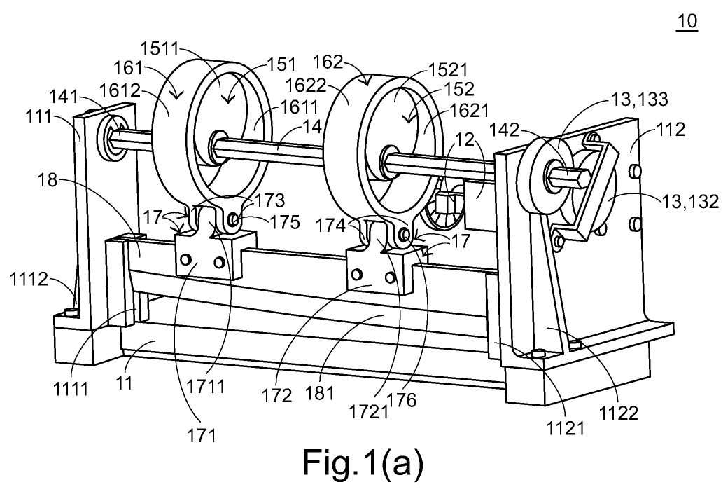

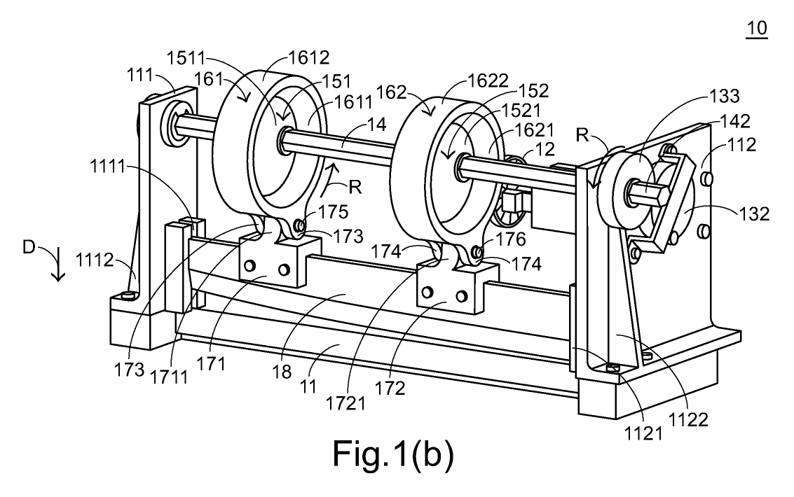

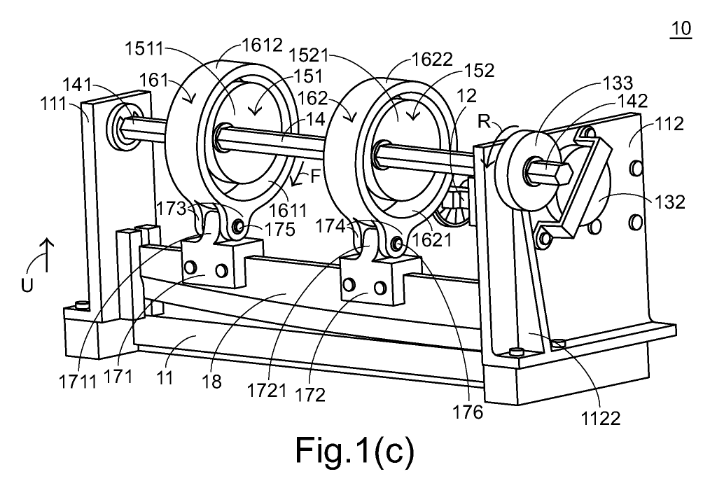

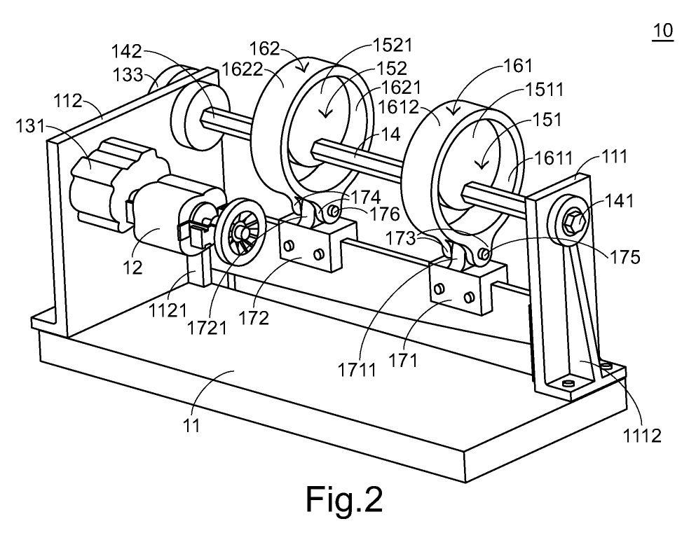

Hereinafter, the successive operations of a cutting apparatus according to the present invention will be illustrated in more details with reference to FIGS. 1(a), 1(b) and 1(c). In FIG. 1(a), the cutting apparatus 10 is operated in a standby mode. In FIG. 1(b), the cutting member 18 of the cutting apparatus 10 is lowered to perform a cutting operation. In FIG. 1(c), the cutting member 18 of the cutting apparatus 10 is uplifted. FIG. 2 is a rear view of the cutting apparatus shown in FIG. 1(a).

Please refer to FIG. 1(a) and also FIG. 2. The cutting apparatus 10 principally includes a cutting platform 11, a motor 12, a gear set 13, a rotating shaft 14, two eccentric rollers 151 and 152, two ring-shaped collars 161 and 162, a coupling member 17 and a cutting member 18. A first lateral plate 111 and a second lateral plate 112 are arranged at opposed sides of the cutting platform 11 in the length direction. A first guiding track 1111 and a second guiding track 1121 are arranged on the first lateral plate 111 and the second lateral plate 112, respectively, and face to each other.

For facilitating the first lateral plate 111 and the second lateral plate 112 to be stably stood on the cutting platform 11 during the cutting operation, the first lateral plate 111 and the second lateral plate 112 are supported by a first inclined plate 1112 and a second inclined plate 1122, respectively.

The motor 12 is mounted on the cutting platform 11 and behind the cutting member 18. The gear set 13 includes a first gear part and a second gear part. The first gear part 131 is disposed at a first surface of the second lateral plate 112 and rotatably connected to the motor 12, as is shown in FIG. 2. The second gear part is disposed at a second surface of the second lateral plate 112, and includes a first gear 132 and a second gear 133 engaging with each other. The first gear 112 of the second gear part is rotatably connected to the first gear part 131. The second gear 133 of the second gear part is rotatably connected to a second end 142 of the rotating shaft 14. For illustration, the motor 12 and the gear set 13 are also cooperatively referred as an automatic transmission member.

The first end 141 and the second end 142 of the rotating shaft 14 penetrate through the first lateral plate 111 and the second lateral plate 112, so that the rotating shaft 14 is rotatable between the first lateral plate 111 and the second lateral plate 112.

The cutting member 18 movable along the first guiding track 1111 and the second guiding track 1121 in the upward or downward direction. The cutting member 18 has a knife edge 181 for cutting sheet articles such as papers. In this embodiment, the knife edge 181 is made slanted and curved. It is noted that, however, those skilled in the art will readily observe that numerous modifications and alterations of the knife edge 181 may be made while retaining the teachings of the invention. For example, the knife edge 181 having a wavy or saw-toothed structure is feasible for implementing the cutting operation.

In accordance with a feature of the present invention, the eccentric rollers 151 and 152 are sheathed around the rotating shaft 14 and enclosed by the ring-shaped collars 161 and 162, respectively. The rolling surfaces of the eccentric rollers 151 and 152 are sustained against the inner surfaces 1611 and 1621 of the ring-shaped collars 161 and 162, respectively. The coupling member 17 includes two clamping blocks 171 and 172, two first pivotal hole pedestals 1711 and 1721, two second pivotal hole pedestals 173 and 174, and two movable bolts 175 and 176. The upper edge of the cutting member 18 is clamped by the clamping blocks 171 and 172. The first pivotal hole pedestals 1711 and 1721 are extended from the top surfaces of the clamping blocks 171 and 172, respectively. The second pivotal hole pedestals 173 and 174 are extended from the outer surfaces 1612 and 1622 of the ring-shaped collars 161 and 162, respectively. The movable bolt 175 penetrates through the second pivotal hole pedestal 173 and the first pivotal hole pedestal 1711 such that the ring-shaped collar 161 is pivotally coupled to the clamping block 171. Likewise, the movable bolt 176 penetrates through the second pivotal hole pedestal 174 and the first pivotal hole pedestal 1713 such that the ring-shaped collar 162 is pivotally coupled to the clamping block 172.

It is preferred that the first pivotal hole pedestal 1711 and the second pivotal hole pedestal 173 have complementary shapes, and the first pivotal hole pedestal 1721 and the second pivotal hole pedestal 174 have complementary shapes. For example, if the first pivotal hole pedestals 1711 and 1721 are male-shaped, the second pivotal hole pedestals 173 and 174 are female-shaped. Whereas, if the first pivotal hole pedestals 1711 and 1721 are female-shaped, the second pivotal hole pedestals 173 and 174 are male-shaped.

It is noted that, however, those skilled in the art will readily observe that numerous modifications and alterations of the pivotal hole pedestals 1711, 1721, 173 and 174 may be made while retaining the teachings of the invention. For example, the first pivotal hole pedestals 1711 and 1721 are integrally formed on the upper edge of the cutting member 18. Alternatively, the second pivotal hole pedestals 173 and 174 are individual components and fastened to the outer surfaces 1612 and 1622 of the ring-shaped collars 161 and 162, respectively. Accordingly, the above disclosure should be limited only by the bounds of the following claims.

Please refer to FIGS. 1(a), 1(b) and 1(c). The successive operations of the cutting apparatus 10 will be illustrated as follows.

In FIG. 1(a), the cutting apparatus 10 is operated in a standby mode. The eccentric rollers 151 and 152, which are sheathed around the rotating shaft 14, are rotated upwardly to have the sustaining parts 1511 and 1521 to be sustained against the inner surfaces 1611 and 1621 of the ring-shaped collars 161 and 162, respectively. Under this circumstance, the cutting member 18 which is linked to the ring-shaped collars 161 and 162 via the coupling member 17 is moved along the first guiding track 1111 and the second guiding track 1121 to the uppermost ends thereof.

After the motor 12 is started, the first gear part 131 and the first gear 132 and the second gear 133 of the second gear part are driven to rotate and thus the rotating shaft 14 is rotated in a circular motion along either the clockwise direction or the anti-clockwise direction. In this embodiment, since the rotating shaft 14 is rotated in a circular motion along the anti-clockwise direction R, the sustaining parts 1511 and 1521 of the eccentric rollers 151 and 152 are driven to rotate along the anti-clockwise direction R, as is shown in FIG. 1(b). As a consequence, the sustaining parts 1511 and 1521 are moved in ring-shaped trajectories to be respectively sustained against the inner surfaces 1611 and 1621 of the ring-shaped collars 161 and 162. After the sustaining parts 1511 and 1521 of the eccentric rollers 151 and 152 are rotated for about one-fourth turn, the ring-shaped collars 161 and 162 will be switched to swing along the anti-clockwise direction F due to mechanical transmission. Meanwhile, the second pivotal hole pedestals 173 and 174 are respectively sustained against the clamping blocks 171 and 172, so that the cutting member 18 will be moved along the first lateral plate 111 and the second lateral plate 112 in a downward direction D to implement the cutting operation.

Subsequently, the sustaining parts 1511 and 1521 of the eccentric rollers 151 and 152 are rotated along the anti-clockwise direction R for about one-half turn to be respectively sustained against the inner surfaces 1611 and 1621 of the ring-shaped collars 161 and 162. At that moment, the sustaining parts 1511 and 1521 are directly located above the cutting member 18, and the first pivotal hole pedestals 1711 and 1721 are linearly aligned with the second pivotal hole pedestals 173 and 174, respectively.

Continuously, the sustaining parts 1511 and 1521 of the eccentric rollers 151 and 152 are rotated along the anti-clockwise direction R and the ring-shaped collars 161 and 162 are swung along the anti-clockwise direction F, as can be seen in FIG. 1(c). After the sustaining parts 1511 and 1521 of the eccentric rollers 151 and 152 are rotated for about three-fourth turn, the ring-shaped collars 161 and 162 will be switched to swing along the clockwise direction R due to mechanical transmission. Meanwhile, the clamping blocks 171 and 172 will be uplifted by the second pivotal hole pedestals 173 and 174, so that the cutting member 18 will be moved along the first lateral plate 111 and the second lateral plate 112 in an upward direction U to uplift the cutting member 18.

Afterwards, the sustaining parts 1511 and 1521 of the eccentric rollers 151 and 152 are continuously rotated along the anti-clockwise direction R until the cutting member 18 is moved to the original position as shown in FIG. 1(a), the first pivotal hole pedestals 1711 and 1721 are linearly aligned with the second pivotal hole pedestals 173 and 174, respectively. In other words, the cutting member 18 is moved along the first guiding track 1111 and the second guiding track 1121 to the uppermost ends thereof.

For illustration, the eccentric rollers 151 and 152, the ring-shaped collars 161 and 162 and the coupling member 17 are cooperatively referred as a rotational direction switching unit. By means of the rotational direction switching unit, the circular motions of the eccentric rollers 151 and 152 are switched to the linear cutting motions of the cutting member 18.

It is noted that, however, those skilled in the art will readily observe that numerous modifications and alterations of the cutting apparatus may be made while retaining the teachings of the invention. For example, the ring-shaped collars 161 and 162 and the coupling member 17 are omitted, but the eccentric rollers 151 and 152 are directly sustained against the upper edge of the cutting member 18. Alternatively, respective resilient elements (not shown) are received in the first guiding track 1111 and the second guiding track 1121. The restoring forces generated from the compressed resilient elements will facilitate close contact between the eccentric rollers 151, 152 and the cutting member 18 so as to be synchronously shifted upwardly or downwardly.

Moreover, the cutting apparatus of the present invention is capable of cutting various sheet articles with different thickness by changing the gear ratio of the gear set 13 or adjusting the sizes of the eccentric rollers 151, 152, the ring-shaped collars 161, 162 and the guiding tracks 1111, 1121. As a result, the cutting apparatus of the present invention is advantageous of having extensible applications and simple configurations.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cutting apparatus comprising:
a cutting platform;
a first lateral plate and a second lateral plate arranged at opposed sides of said cutting platform;
a first guiding track and a second guiding track arranged on said first lateral plate and said second lateral plate, respectively, and facing to each other;
a motor disposed on said cutting platform;
a gear set including a first gear part and a second gear part disposed on a first surface and a second surface of said second lateral plate, respectively, wherein said first gear part is connected to said motor;
a cutting member arranged between said first guiding track and said second guiding track and movable along said first guiding track and said second guiding track;
a rotating shaft having a first end and a second end penetrating through said first lateral plate and said second lateral plate, respectively, wherein said second end of said rotating shaft is rotatably connected to said second gear part of said gear set; and
a rotational direction switching unit interconnected between said rotating shaft and said cutting member and including a sustaining member sheathed around said rotating shaft, wherein said sustaining member is sustained against said cutting member thereunder to transmit a linear cutting operation of said cutting member when said rotating shaft is driven by said second gear part of said gear set to rotate in a circular motion.

2. The cutting apparatus according to claim 1 wherein said first guiding track and said second guiding track are arranged in a vertical direction such that said cutting member is moved along said first guiding track and said second guiding track to implement said linear cutting operation in said vertical direction.

3. The cutting apparatus according to claim 1 wherein said cutting member has a slanted and curved knife edge.

4. The cutting apparatus according to claim 1 wherein said second gear part of said gear set includes a first gear and a second gear engaging with each other, said first gear of said second gear part is rotatably connected to said first gear part, and said second gear of said second gear part is rotatably connected to said second end of said rotating shaft.

5. The cutting apparatus according to claim 1 wherein said sustaining member is an eccentric roller.

6. The cutting apparatus according to claim 5 wherein said rotational direction switching unit further includes a ring-shaped collar enclosing said eccentric roller, wherein said eccentric roller has a rolling surface sustained against an inner surface of said ring-shaped collar.

7. The cutting apparatus according to claim 6 further comprising a coupling member between said ring-shaped collar and said cutting member to transmit said linear cutting operation of said cutting member when said rotating shaft is rotated in said circular motion to have said eccentric roller sustained against said inner surface of said ring-shaped collar.

8. The cutting apparatus according to claim 7 wherein said coupling member comprises:
a clamping block for clamping an upper edge of said cutting member, wherein a first pivotal hole pedestal is extended from a top surface of said clamping block;
a second pivotal hole pedestal extended from an outer surface of said ring-shaped collar; and
a movable bolt penetrating through said second pivotal hole pedestal and said first pivotal hole pedestal such that said ring-shaped collar is pivotally coupled to said clamping block.

9. The cutting apparatus according to claim 8 wherein said first pivotal hole pedestal and said second pivotal hole pedestal are respectively male-shaped and female-shaped, or said first pivotal hole pedestal and said second pivotal hole pedestal are respectively female-shaped and male-shaped.

10. A cutting apparatus comprising:
a motor;
a gear set including a first gear part and a second gear part, wherein said first gear part is rotatably connected to said motor;
a rotating shaft penetrating through two lateral plates, respectively, wherein an end of said rotating shaft is rotatably connected to said second gear part of said gear set;
a cutting member arranged between a first guiding track and a second guiding track and movable along said first guiding track and said second guiding track; and
an eccentric sustaining member sheathed around said rotating shaft and disposed above said cutting member, wherein said eccentric sustaining member is sustained against said cutting member to transmit a linear cutting operation of said cutting member when said rotating shaft is driven by said second gear part of said gear set to rotate in a circular motion.

11. The cutting apparatus according to claim 10 wherein said first guiding track and said second guiding track are arranged on said first lateral plate and said second lateral plate, respectively, wherein said first guiding track and said second guiding track are arranged in a vertical direction such that said cutting member is moved along said first guiding track and said second guiding track to implement said linear cutting operation in said vertical direction

12. The cutting apparatus according to claim 10 wherein said gear set is disposed on one lateral plate of said two lateral plates, and said first gear part and said second gear part of said gear set are disposed on opposed surfaces of said one lateral plate, respectively.

13. The cutting apparatus according to claim 12 wherein said second gear part of said gear set includes a first gear and a second gear engaging with each other and disposed on the same surface of said one lateral plate, said first gear of said second gear part is rotatably connected to said first gear part, and said second gear of said second gear part is rotatably connected to said end of said rotating shaft.

14. The cutting apparatus according to claim 10 wherein said cutting member has a slanted and curved knife edge.

15. The cutting apparatus according to claim 10 wherein said eccentric sustaining member is an eccentric roller.

16. The cutting apparatus according to claim 15 further comprising:
a ring-shaped collar enclosing said eccentric roller, wherein said eccentric roller has a rolling surface sustained against an inner surface of said ring-shaped collar; and
a coupling member between said ring-shaped collar and said cutting member to transmit said linear cutting operation of said cutting member when said rotating shaft is rotated in said circular motion to have said eccentric roller sustained against said inner surface of said ring-shaped collar.

17. The cutting apparatus according to claim 16 wherein said coupling member comprises:
a clamping block for clamping an upper edge of said cutting member, wherein a first pivotal hole pedestal is extended from a top surface of said clamping block;
a second pivotal hole pedestal extended from an outer surface of said ring-shaped collar; and
a movable bolt penetrating through said second pivotal hole pedestal and said first pivotal hole pedestal such that said ring-shaped collar is pivotally coupled to said clamping block.

18. A cutting apparatus comprising:
a cutting platform;
an automatic transmission member disposed on said cutting platform;
a first lateral plate and a second lateral plate arranged at opposed sides of said cutting platform;
a rotating shaft penetrating through two lateral plates, respectively, wherein an end of said rotating shaft is rotatably connected to a gear part of said gear set;
a cutting member arranged between a first guiding track and a second guiding track and movable along said first guiding track and said second guiding track; and
an eccentric sustaining member sheathed around said rotating shaft and disposed above said cutting member, wherein said eccentric sustaining member is sustained against said cutting member to transmit a linear cutting operation of said cutting member when said rotating shaft is driven by said gear part to rotate in a circular motion.

19. The cutting apparatus according to claim 18 wherein said automatic transmission member comprises:
a motor disposed on said cutting platform; and
a gear set including said gear part and another gear part, which are disposed on opposed surfaces of one lateral plate of said two lateral plates, wherein said another gear part is rotatably connected to said motor.

20. The cutting apparatus according to claim 19 wherein said gear part of said gear set includes a first gear and a second gear engaging with each other and disposed on and disposed on the same surface of said one lateral plate, said first gear is rotatably connected to said first gear part, and said second gear is rotatably connected to said end of said rotating shaft.

21. The cutting apparatus according to claim 18 wherein said first guiding track and a second guiding track are arranged on said first lateral plate and said second lateral plate, respectively, wherein said first guiding track and said second guiding track are arranged in a vertical direction such that said cutting member is moved along said first guiding track and said second guiding track to implement said linear cutting operation in said vertical direction

22. The cutting apparatus according to claim 18 wherein said cutting member has a slanted and curved knife edge.

23. The cutting apparatus according to claim 18 wherein said eccentric sustaining member is an eccentric roller.

24. The cutting apparatus according to claim 23 further comprising:
a ring-shaped collar enclosing said eccentric roller, wherein said eccentric roller has a rolling surface sustained against an inner surface of said ring-shaped collar; and
a coupling member between said ring-shaped collar and said cutting member to transmit said linear cutting operation of said cutting member when said rotating shaft is rotated in said circular motion to have said eccentric roller sustained against said inner surface of said ring-shaped collar.

25. The cutting apparatus according to claim 24 wherein said coupling member comprises:
a clamping block for clamping an upper edge of said cutting member, wherein a first pivotal hole pedestal is extended from a top surface of said clamping block;
a second pivotal hole pedestal extended from an outer surface of said ring-shaped collar; and
a movable bolt penetrating through said second pivotal hole pedestal and said first pivotal hole pedestal such that said ring-shaped collar is pivotally coupled to said clamping block.
